(19) United States
(12) Patent Application Publication
(10) Pub. No.: US 2018/0376225 A1
(43) Pub. Date: Dec. 27, 2018

(54) MUSIC VIDEO RECORDING KIOSK

(71) Applicant: Metrolime, Inc., Carolina, PR (US)

(72) Inventors: Allan Scott Jones, Carolina, PR (US); Luke David Jones, Carolina, PR (US); Paul Bahnsen Jones, Carolina, PR (US); Lydia Esther-Jones Zalesky, Huger, SC (US); Nikolas Alexander Zalesky, Huger, SC (US)

(73) Assignee: Metrolime, Inc., Carolina, PR (US)

(21) Appl. No.: 16/017,154

(22) Filed: Jun. 25, 2018

Related U.S. Application Data
(60) Provisional application No. 62/523,818, filed on Jun. 23, 2017.

(51) Int. Cl. H04N 21/8549; G10H 1/00; G06Q 30/06; H04N 21/8545

(52) U.S. Cl. CPC H04N 21/8549; H04N 21/8545; G06Q 30/0621; G10H 1/0025

(57) ABSTRACT

A music video kiosk that allows users to create studio quality music videos via manipulation of vocal controls as well as integration of instruments.

### BACKGROUND OF THE INVENTION

### 1) Field of the Invention

The present invention relates to a music video kiosk that allows users to experience a wide array of media entertainment through the creation of studio quality music videos, personalized video messages, and interactive photos supported through the manipulation of vocal controls as well as integration of instruments.

### 2) Description of Related Art

Consumers always seek new ways to capture and share their current activities with friends and family. Since the days of the first photo booth, consumers have eagerly sought out ways to commemorate their activities in mediums that can be stored and shared. While technology in these areas has improved markedly, numerous opportunities exist for expanding on what has come before.

For instance, U.S. Pat. No. 9,578,188 (Kircher '188) discloses systems and methods for photo and/or video platform. In an embodiment, a network connected system comprises a touch screen computing device coupled to an image capture apparatus, a ring flash and a local storage. The computing device receives information from a content management system, provides a user interface at the touch screen display to display information and receive input from users, controls the image capture apparatus and the ring flash to capture image of the users, stores the capture image content captured by the image capture apparatus in the local storage, and uploads the capture image content to the content management system. (Abstract.)

However, Kircher '188 fails to provide numerous features present in the current disclosure such as: audible music provided by the kiosk; auditory interaction from user and simultaneous capture of vocal content via microphone; the ability of the user to hear themselves during interaction with the kiosk's computing device via headphones; user control over the experience through searchable content including songs and video experiences stored either locally on the computing device or in cloud-based servers; audio input from user can be manipulated through preset vocal style choices or through advanced options that allows for a completely customizable experience; the kiosk of the current disclosure captures at least one video with studio quality personalized audio.

In another instance, U.S. Pat. No. 9,324,064 (Rivera '064) provides a digital jukebox device with karaoke and/or photo booth features. Rivera '064 discloses a method of recording a karaoke performance in which a karaoke performer sings a song through a first microphone connected to a jukebox that is playing the song, the method comprising: enabling a user to check in to a site where the jukebox is located via an application running on a portable electronic device being operated by the user, the application having access to a karaoke queue maintained by the jukebox, the karaoke queue indicating the songs that are being sung; synchronizing times as between the jukebox and the electronic device upon said check in; causing the electronic device to capture at least video of the karaoke performance mediated by the jukebox.

However, the current disclosure is distinct from Rivera '064 in several ways. Foremost, the current disclosure does not require an external device interaction on the part of the user since the current disclosure kiosk itself records the video in time with each song selected by the user, further the current disclosure's Karaoke queue is managed internally via the kiosk's computing device. Additionally, the current disclosure kiosk has multiple studio quality microphones integrated into the kiosk that allow for multiple users to sing at once, thus, there is no low-quality audio collected in conjunction with video capture of the kiosk. Further, the kiosk of the current disclosure instantly creates the user's music video with high quality visual and auditory data, thereby rendering synchronization of various elements as required by Rivera '064 as irrelevant. Further, for the current disclosure kiosk, audiovisual files are instantly uploaded to a server that is accessible to the user for sharing via link on any means of online or cellular communication. Additionally, all karaoke music audio for the kiosk of the current disclosure is played through studio quality headphones connected to the kiosk and allows users to hear themselves singing while simultaneously preventing intrusion of ambient noise of the music. Moreover, the kiosk of the current disclosure is comprised of soundproofing material to prevent any outside noise from disrupting the quality of the music video recording. This sound proofing also prevents singing within the kiosk from disrupting any ambience outside in the host location. Further, the current disclosure stores all songs locally on the kiosk. This eliminates download times for users when they selected a song.

U.S. Pat. No. 8,957,942 (Ryckman '942) discloses a studio booth configured to produce illusion that customer is photographed in different locale. Ryckman '942 provides a method of producing a performance in an enclosure including: providing an audio and video system for recording the performance, providing a computer system for displaying a performance backdrop on a chroma key screen, and providing a transmitter for sending the recording to a selected location outside the enclosure for personal use or submission to friends, family, or an authorized contest. The method further includes minimizing perspective distortion and subject distortion on the recording, and providing a final recording that presents the illusion that the individual is located in an area larger than the enclosure in which the performance was produced. (Abstract.)

The current disclosure possesses several distinctions over Ryckman '942 For instance, only one video lens choice is necessary as the enclosure will not change. Further, only one backdrop is needed on the inside of the kiosk door that will serve as the music video background. Additionally, the user's recording is uploaded to a content management server rather than transmitted to an outside location for easy access by users to share content via links to the music video location. Moreover, making the kiosk of the current enclose soundproof will prevent ambient noise from disrupting the quality of the music video recording. Additionally, the microphone in the kiosk of the current disclosure will work with the kiosk's computing device to alter audio input to enhance the quality, or the perceived quality, of the user's performance given the users previous choice of vocal effect. Further, the kiosk will possess headphones within the kiosk to play music that will make up a large portion of the audio in the final music video file. Another distinction is that the kiosk of the current disclosure will not be transmitting a live performance, rather it will be recording a studio quality music video uploaded to a server where users can view and share their created content. Further, the kiosk of the current disclosure gives users the choice of using their instruments as part of the video creation experience.

U.S. Pat. No. 8,508,572 (Ryckman '572) discloses a live broadcast interview conducted between studio booth and interviewer at remove location. Ryckman '572 provides a portal for an individual to access a web site for establishing personal relationships. The method includes the step of providing a portal booth to photograph the individual while the individual is in said booth to produce a photographic record of the individual, correlate selected demographic data about the individual with said photographic record, and transmit the photographic record and demographic data to the web site. The method also includes the step of correlating the photographic record and demographic data with an account for the individual at the web site such that other individuals can access the web site and the account to view at least said photographic record of said individual.

Ryckman '572 also lacks various elements of the current disclosure, including playing pre-recorded audio through the kiosks computer system that the user will then sing to in accompaniment. These vocal inputs will then be recorded and overlaid onto the pre-recorded audio to complete the audio portion of the user's music video. The current disclosure also lacks the speaker system required by Ryckman '572. The current disclosure also provides preset vocal adjustments to audio input chosen by users before recording has begun.

U.S. Pat. No. 8,269,900 (O'Connell '900) discloses a mobile studio for producing video and audio content that includes a vehicle having a body mounted on a chassis. The body includes a studio chamber enclosure formed by a floor, a ceiling, spaced opposite outer side walls and spaced outer front and rear walls, and the floor includes a stage area. The mobile studio further includes at least one LED lighting assembly located in the studio chamber enclosure that is suitable for providing sufficient illumination for image capture such that a captured image is suitable for projection as a Pepper's Ghost image, at least one camera to capture an image of a subject on the stage area and generate the captured image, and a communications device to transmit the captured image. (Abstract)

The current disclosure does away with the need for projectors or transparent screens, as the main image capturing system will be video. No Pepper's Ghost image is involved in the recording, rather the user's image is captured via camera attached to the monitor with the background determined by the user. Further, there will be no use of a transmitter, rather captured content will be uploaded to a server where customers can access and share their creations via SMS links. Additionally, at least one video monitor will be displaying the recording itself so users can witness the video being made. Further, an audio recording device will alter audio inputs as they are collected in order to enhance the performance of the user. Even further, the kiosk of the current disclosure will have sound proofing glass in addition to sound proofing materials on the walls of the kiosk.

U.S. Pat. No. 6,086,380 (Chu '380) discloses a self-operated karaoke recording booth. A user is provided with a selection of background scenes from which to choose and also with the option of having the lyrics of the karaoke selection displayed or suppressed. A video camera positioned at the user's eye level is located on the nonreflective side of a one-way mirror and is directed at a specified performer location through the one-way mirror, which is inclined at a forty-five degree angle relative thereto. Messages and video displays are provided to the user by a video display monitor connected to a computer that faces the reflective side of the one-way mirror and is also located at a forty-five degree angle relative thereto. The system is designed to maintain the visual focus of the performer directly into the lens of the video camera throughout the performance and to combine the video camera images with the background scene in such a way as to avoid a double exposure or phantom image of the performer against the background. The performer can choose to have the lyrics of the selected karaoke composition displayed or suppressed. If the election is for a display, the lyrics are displayed at the center of the viewing screen, directly in line with the video camera. (Abstract.)

The current disclosures defines over Chu '380 in various ways, including being designed for use by multiple people simultaneously as well as all non-computing equipment is visible to the user. Further, the video camera for the kiosk of the current disclosure is located at the top of the kiosk and viewing screen will only show words overlaid on a streamed recording of the user. Further, no mirror is needed as a video camera will be placed above the display screen. Also, the current disclosure does not employ speakers as it uses multiple headphones. Moreover, audio and video are simultaneously recorded during studio performance via video camera and microphone input data. Even further, song selection will be integrated into the user interface and songs will be stored on a local and cloud-based server that will either play immediately or download then play. Further, there is no background selection, background is streamed video recording. Furthermore, the interface of the current disclosure is much simplified; after payment, users will simply choose their song, select their vocal style, then begin recording, lyrics will automatically be displayed on top of a recording screen. With respect to securing a copy of the work produced, the kiosk of the current disclosure provides that recording will take place simultaneously and will be completely digital, users will not receive a physical copy or means of owning their video, rather they will receive links via MMS message to a content management system that hosts their videos, from there users can share their videos via links to social media or through other communication means.

U.S. Pat. No. 6,085,195 (Hoyt '195) discloses a computer program product for an interactive public kiosk including a processor for automatically forming a web page including an image of a user, comprising: a computer readable media including: code that directs the processor to capture an image of the user; code that directs the processor to modify the image according to a user selected theme to form a modified image; code that directs the processor to determine a URL address for the web page; code that directs the processor to create a file in response to the user selected theme and the modified image; and code that directs the processor to upload the file to be located at the URL address to a server.

The kiosk of the current disclosure defines over Hoyt '195 in several ways. For instance, the current kiosk creates music videos with preset vocal styles input by the user before video recording. Further, a completed video is available for viewing/sharing only after accessing link with temporary password/making an account and being made public. Moreover, music video is recorded without any need to modify the creation, vocal effects and video background are already set at the time of recording. Thus, the video file created can be uploaded instantly. Additionally, the kiosk of the current disclosure creates music videos with preset vocal styles input by the user before video recording. Thus, the video file created can be uploaded instantly.

US Pat. Pub. 2016/0205354 (Stephens '354) discloses a video communication system including a kiosk for recording video messages created by a user and a database for storing and providing access to the video messages. The kiosk includes a user interface for receiving user information such as name, address, email, and other identifying information. The kiosk further includes a message-recording device for recording a user video message. The video message and user message data are uploaded to a database. The database reconnects with the user through the user information to allow the user to access the video message. In an embodiment, the database sends an email web link to the user. The user may view the video message by opening the email web link and viewing the video message on an internet website. (Abstract.)

The kiosk of the current disclosure defines over Stephens '354 via receiving audio and video input data from a user not simply image data. Additionally, the current disclosure does not transmit data, rather uploads it to a content management server which the user receives a link to via MMS message wherein the kiosk is configured to receive input relating to a selection of an image to be combined with the media data. Moreover, the current disclosure kiosk automatically combines video and audio data collected from user into final music video as well as delivers link of video to the user via MMS message.

Prior case: U.S. Pat. No. 8,619,115 (Stephens '115) provides a video communication system including a kiosk for recording video messages created by a user and a database for storing and providing access to the video messages. The kiosk includes a user interface for receiving user information such as name, address, email, and other identifying information. The kiosk further includes a message-recording device for recording a user video message. The video message and user message data are uploaded to a database. The database reconnects with the user through the user information to allow the user to access the video message. In an embodiment, the database sends an email web link to the user. The user may view the video message by opening the email web link and viewing the video message on an internet website. (Abstract.)

The current disclosure defines over Stephens '115 in various ways, including interaction by user on a touch screen interface to select song and thus personalize their experience, selection of vocal effects by the user to personalize their experience, soundproofing of the kiosk, headphones for music to preserve audio quality, a user is given access to video on website via MMS text, audio data collected via 4 microphones within kiosk, a touchscreen on the outside of the kiosk showing song choices to prep next user before entering the kiosk, music lyrics are shown on display screen to facilitate user interaction, as well as the ability to plug instruments into the kiosk and use these during the performance as part of the experience.

Accordingly, it is an object of the present invention to provide an improved music video kiosk that provides more functionality to the user such as by allowing studio quality music production in association with enhanced features and selections available to the user. Further, the current kiosk can allow a multi-user experience with different individuals simultaneously performing and creating a finished music video product. In addition, the finished product may not only be accompanied by instruments but is also shareable.

### SUMMARY OF THE INVENTION

In a further embodiment, a multi-media kiosk is provided. The kiosk may include a kiosk shell, a user interface on an exterior of the kiosk, a home screen located within the kiosk shell, at least one camera within the kiosk shell, at least one microphone within the kiosk shell, wherein the multi-media kiosk allows for creation of music videos, video messages, or taking photographs, all within the kiosk. Further, the user interface provides access to a song catalog. Still further, the home screen allows application of vocal controls to modify audio characteristics of the music videos and video messages. Further yet, the kiosk contains at least one hands-free microphone built into the kiosk shell and at least one hand-held microphone within the kiosk shell. Still yet further, the kiosk allows creation of customized music videos, video messages and/or photographs. Yet further, the kiosk allows for selecting a customized background for the music videos, video messages and/or photographs. Furthermore, the kiosk allows for editing photographs. Still again, the kiosk transmits a link allowing access to completed music videos, video messages, or photographs crated via the kiosk. Again further, the kiosk shell may be customized by changing an outer appearance of the kiosk shell. Further again, a mixer board is included in the kiosk to allow for control of the audio characteristics of the music videos and video messages. The kiosk further includes inputs for musical instruments. Still yet, head phones and speakers are provided to allow hearing audio from the kiosk. The kiosk further comprises sound proofing material substantially surrounding an interior of the kiosk.

In an alternative embodiment, a multi-media kiosk is provided that includes a kiosk shell, a user interface, a home screen located within the kiosk shell, at least one camera within the kiosk shell, at least one microphone within the kiosk shell, wherein the multi-media kiosk allows a user to choose among creating music videos, creating video messages, or taking photographs, all within the kiosk, and the kiosk allows for hands-free operation or directed input via headphones and at least one hand-held microphone. Further, the home screen allows application of vocal controls to modify audio characteristics of the music videos and video messages. Still further, the kiosk contains at least one hands-free microphone built into the kiosk shell and at least one hand-held microphone within the kiosk shell. Further yet, the kiosk allows for selecting a customized video background. Again further, the kiosk allows for editing photographs. Furthermore, the kiosk transmits a link allowing access to completed music videos, video messages, or photographs crated via the kiosk. Again further still, the kiosk shell may be customized by changing an outer appearance of the kiosk shell.

In a further embodiment, a mobile multi-media kiosk is provided. The mobile kiosk includes a kiosk shell, a user interface, a home screen located within the kiosk shell, at least one camera within the kiosk shell, at least one microphone within the kiosk shell, wherein the mobile multi-media kiosk allows a user to choose among creating music videos, creating video messages, or taking photographs, all within the kiosk. Still further, the mobile kiosk allows for hands-free operation or directed input via headphones and at least one hand-held microphone, and the mobile kiosk components are detachably joined and may be dismantled and reassembled in various locales.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a schematic of one embodiment of the current disclosure.

FIG. 2 shows one embodiment of a user interface of the current disclosure.

FIG. 3 shows one example of communication between a kiosk of the current disclosure and a content server.

FIG. 4 shows one embodiment of user interaction with a kiosk of the current disclosure.

FIG. 5A shows a front view of one embodiment of a user interface for kiosks of the current disclosure.

FIG. 5B shows a side view of one embodiment of a user interface for kiosks of the current disclosure.

FIG. 6A shows a side view of a kiosk shell of the current disclosure.

FIG. 6B shows an angled rear view of a kiosk shell of the current disclosure.

FIG. 7 shows one embodiment of a start screen that may be used with a kiosk of the current disclosure.

FIGS. 8A, 8B, and 8C show embodiments of selection screens that may be used with a kiosk of the current disclosure.

FIGS. 9A, 9B and 9C show different views of one embodiment of the current disclosure.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

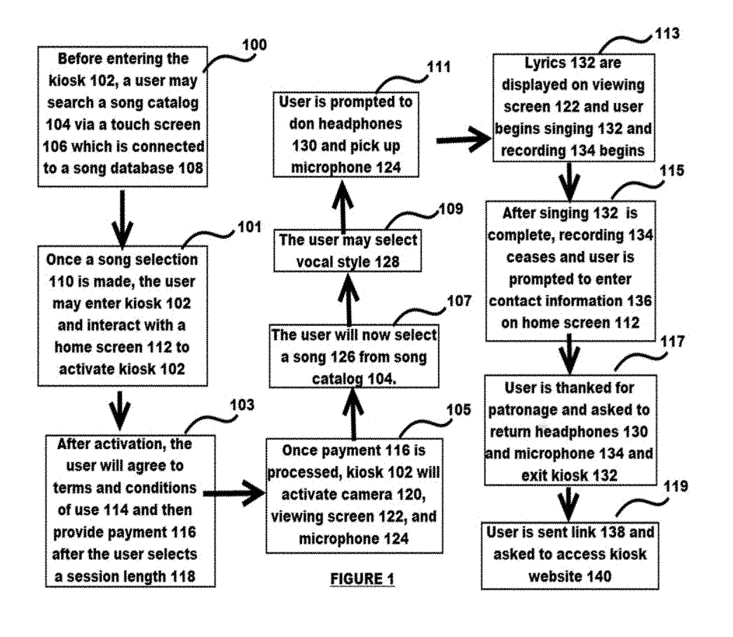

FIG. 1 shows a schematic of one embodiment of the invention. At step 100, a user, before entering kiosk 102, may search a song catalog 104 via interaction with a touch screen 106. Touchscreen 106 may be positioned on an outer surface of kiosk 102 showing song choices to prep the next user before they enter kiosk 102. Touch screen 106 is connected, via wireless connection, wired connection, Bluetooth, IR, or other means as known to those of skill in the art, to a song database 108 through a network, not shown, wherein kiosk 102 may be wirelessly connected to a network via an independent connection supplied by a router or personal Wi-Fi hotspot. The song database may be stored internally on kiosk 102 via a computer and may be updated during off user hours when the cloud based server receives new songs. At step 101, once a song selection 110 is made, the user may enter kiosk 102 and interact with a home screen 112, which may be an additional touchscreen or other user-interactive interface, to activate kiosk 102. At step 105, after activation, the user will be asked to agree to terms and conditions of use 114 and then provide payment 116. Payment may be either cash or electronic forms of payment including PayPal®, BitCoin, credit card, etc. At step 104, once payment 116 is processed, kiosk 102 will activate camera 120, viewing screen 122, and microphone 124. This may include video cameras of all types including wide angle high see, etc. Once kiosk 102 activates viewing screen 122, a user, or users as kiosk 102 may accommodate multiple users, will see themselves on viewing screen 122.

At step 105, a user will now select a song 126 from song catalog 104. A user may either select multiple songs at this step or select a first song and a second song after the first production is complete. If multiple songs are selected, these will be provided to the user in sequence, or the user may determine the order the songs are provided via kiosk 102. Songs are updated automatically when new songs are added to song database 108. All songs may be stored locally on kiosk 102. The current disclosure may store all songs locally on the kiosks. This eliminates download time for users when they select a song. Storing songs locally on kiosk 102 allows for the user to instantly play the song they desire to sing. This is useful for a number of reasons. First, it allows the user to make the most of their time in kiosk 102 as there may be a time limit to each user interaction with the kiosk, for purposes of example only, such as 7 min from the time of payment to record 1 song. This time limit may be visible to the user on the touch screen. Removing download time from the cloud-based server will allow the user ample time to choose and record their song. Second, storing the songs internally will allow for instant gratification for user purchases within the kiosk. Third, storing songs locally will eliminate user confusion throughout the entire experience: no user will spend time outside the kiosk searching for songs to find that their song choice is not actually on the kiosk. Fourth, users will not feel as though their song choice was a poor one if the song has never been sung before, i.e., the song is already present at kiosk 102 and will not need to be downloaded. Thus, the user is unaware if they are the first or four hundredth person singing a particular song.

At step 107, the user selects their “vocal style” 128. Vocal style 128 may be preset voice effects linked to ideal sounds for different genres of music programmed into the computer. For example, a user singing an opera will have a different vocal style than one choosing to sing pop music, country, or death metal. Users can select the vocal style 128 matching their song choice for optimum sound, or may apply a vocal style 128 that is pleasing to the user, although not designed for that particular genre of song. Further, if multiple songs are selected when the users provides payment 116, the user will select their vocal style again after choosing their second song, again after choosing their third song, etc.

At step 109, the user is prompted to don headphones 130 and pick up microphone 124. Kiosk 101 may provide a delay at this point to allow the user/users to prepare for singing. After the delay is complete, the first song play through the headphones 130 and lyrics 132 appear on viewing screen 122 overlaid on the image of the users being recorded. Recording may be accomplished by, for purposes of example only, an AKG condenser mic, superlux over ear headphones, 32 inch LCD screen as known to those of skill in the art, a mixer audio processor, such as a Party House Dak 5000, camera type, Amazon/digital ocean cloud server. After singing 132 is complete, the user may choose to sing another song and repeat the recording process. For instance, a user may be brought back to the song selection screen after recording the first song. After recording 134 has finished, the completed production 140 will automatically be uploaded to at least one server 142. In one instance, a user may receive a unique page 144 for completed production 140. After recording 134 is finished, user may additionally be prompted by home screen 112 to provide contact information 136. Contact information 136 could be email accounts, phones numbers, etc. In one embodiment, a user may be allowed to provide multiple phone numbers as contact information 136. By providing this information, the user may receive a link 146, such as a hypertext link, access code, etc., to access completed production 140. If multiple forms of contact information, or multiple types of the same contact information are provided, multiple links 146 may be sent to the user. In a further embodiment, if contact information 136 is already linked to an account 148, completed product 140 will automatically be linked to account 148. At step 117, the user is thanked for their patronage and prompted remove headphones 130, replace microphone 130 and exit kiosk 102. At step 119, user receives link 146, which may be transmitted as a text, email, website link, etc., with a temporary password 148. After following link 146, the user will be prompted to login to unique page 144 with temporary password 148 and create an account 150 that may be used to store completed productions. If the user chooses not to make an account the video can be accessed and managed with contact information 140 and temporary password 148. The completed production 140 may remain on the server and the link will be active for a predetermined amount of time 152 after which it will be deleted. After logging in or creating an account 150, the user can manage their completed projects 140 from their unique page 144 where they can be accessed, viewed, made public, and shared to social media.

In one embodiment, the current disclosure provides a kiosk that will provide personalized music videos as a consumer product via audible, to the user, music provided by the kiosk. The personalized videos will be a studio quality music video uploaded to a server where users can view and share their created content. This is possible through the simultaneous capture of both audio and video during the kiosk performance via video camera and microphone input data.

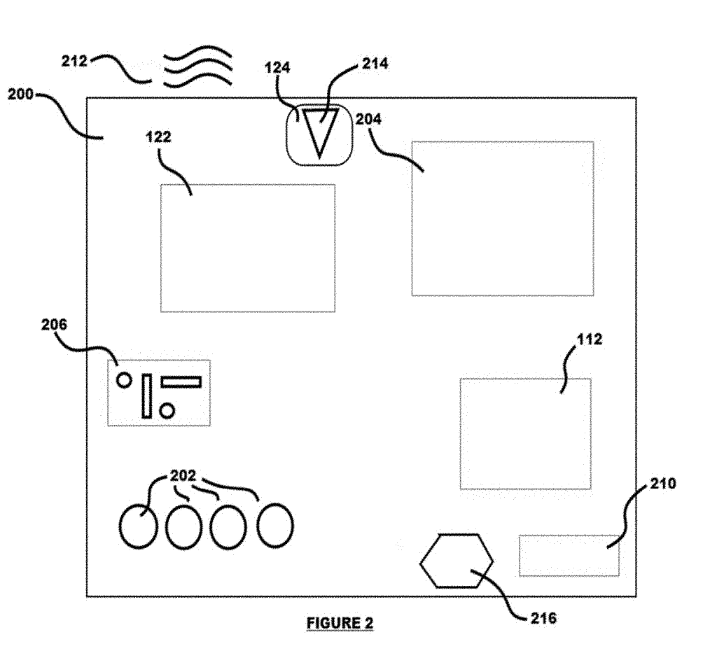

FIG. 2 illustrates one embodiment of a user interface 200. User interface 200 may be positioned on an exterior of kiosk 102. Additionally, the kiosk, via may provide home screen 112 and viewing screen 122 as well as microphone input 202. In addition, a viewing monitor 204 may be provided in order to show the video recording to the user during the recording session so that users can witness the video being made. This heightens the viewing and use experience as the user experiences both the thrill of recording and watching their performance in real time.

User interface 200 may also contain vocal controls 206, which may be used to influence, change, select, or modify vocal style 128. Vocal controls 206 for instance may be a simplified mixer board, which may be a virtual mixer board controlled via user interface 200 or a physical mixer board, that allows the user to control or influence volume, frequency content, stereo position, and/or dynamics and effects of the vocals during the recording. Vocal controls 206 may also allow a user to add sound effects to the recording, incorporate various instruments, etc. For example, a user may control volume, pitch help, reverb, echo, key change, etc.

User interface 200 may also include a headphone jack 208. By connecting a headphone 130 into headphone jack 208, a user will be able to hear themselves during the performance. Indeed, vocal controls 206 may include rewind and/or playback capabilities to allow a user to listen to, and if desired, re-record a section of the audio and video segment. As a price point enhancer, the amount of editing a user may access during a performance may be based on an editing price package such as basic—which would allow minimal vocal changes/edits, premier—allowing for a select numbers of edits, and prestige—which would enable a user to have full access to all vocal/changes edits available via kiosk 102. A user would select the editing price package and pay for same during payment 116. Vocal controls 206 may work with a computing device 210, such as a Party House Dak 5000 mixer audio processor. Computing device 210 may alter audio input to enhance the quality and/or the perceived quality of the user's performance given the users previous choice of vocal style 128.

In an additional embodiment, kiosk 102 may allow multiple users to simultaneously create a completed product 140, including editing and reviewing same, in order to provide a group experience currently lacking in other systems. For purposes of example only, multiple headphone jacks 202 may be provided to accommodate to allow all users to hear the music being played and multiple studio quality microphones 124 may be integrated into kiosk 102 in order to allow for multiple users to sing at once. Additionally, headphones 130 may be studio quality headphones connected that allow the user to hear themselves singing while simultaneously preventing ambient noise of the music.

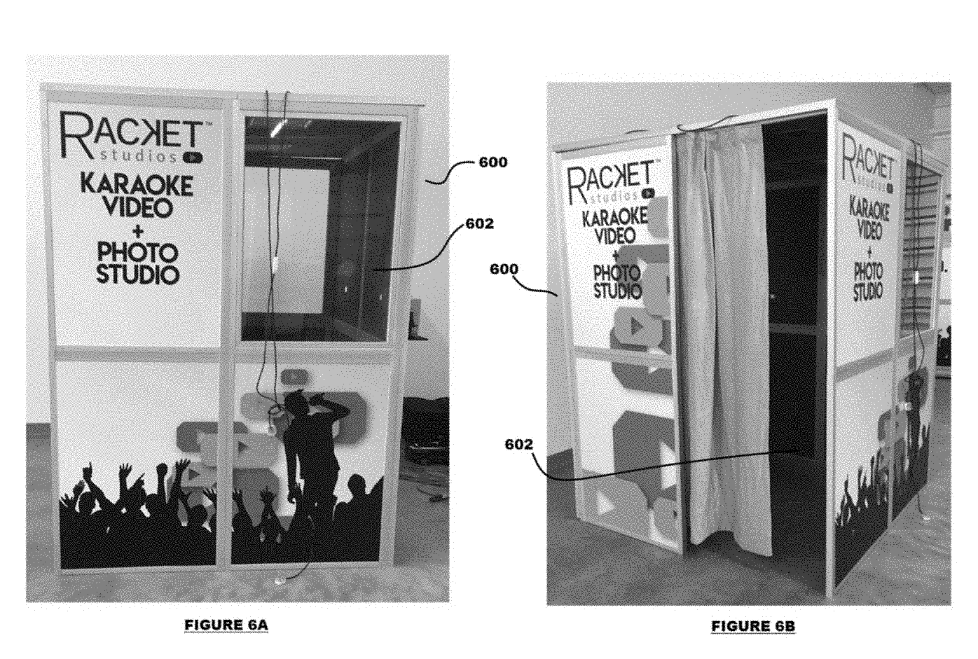

Further, kiosk 102 may be comprised of soundproofing material to prevent any outside noise from disrupting the quality of the music video recording. Soundproofing may be incorporated substantially surrounding the interior 602, see FIG. 6, of kiosk 102. In addition, this soundproofing also prevents singing within kiosk 102 from disrupting any ambience outside in the host location. For purposes of example only, Kiosk 102 may have sound proofing glass in addition to sound proofing materials on the walls of kiosk 102. Thus, kiosk 102 may be located basically anywhere consumers gather as kiosk 102 will not change the “atmosphere” of the locale via leaking music, sound effects, singing, etc. Further, the costs of kiosk 102 may be reduced by having only a single backdrop on the inside of the kiosk door that will serve as the music video background, no additional background selection is necessary. Thus, the current disclosure avoids the use of projectors or transparent screens as the main image capturing system will be digital video via cameras 120.

Headphones 130 may be used to play pre-recorded audio through kiosk 102 computing device 210 that the user will then sing to in accompaniment. These vocal inputs will then be recorded and overlaid onto the pre-recorded audio to complete the audio portion of the user's music video. Because of the innovative design of kiosk 102, there is no speaker system associated with kiosk 102 as all sound is provided to the user through headphones 130.

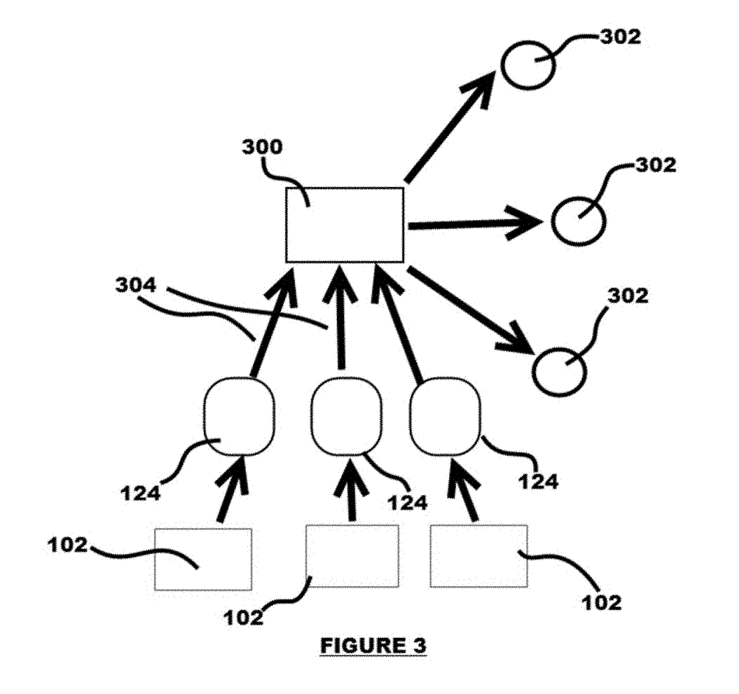

In a further embodiment, sound 212 received from a single user or multiple users via microphone(s) 124 may be converted into input data 124. With respect to FIG. 3, input data 124 may not be stored locally at kiosk 102 but may be automatically uploaded to content servers 300. Content servers 300 may then make input data 124 available to users 302 of kiosk 102. Users will not receive a physical copy or means of owning their video, such as a compact disk, thumb drive, etc., rather they will receive links via a messaging platform, such as MMS, to content servers 300 that host their videos. Users may then access content servers 300 and share their videos via links to social media or through other communication means. The current disclosure provides that a music video is recorded without any need to modify the creation, vocal effects and video background are already set at the time of recording. Thus, the video file created can be uploaded instantly as it is a completed production 140 once the user finishes using kiosk 102.

Returning again to FIG. 2, the current disclosure provides a radical innovation via kiosk 102. Kiosk 102 may provide users the ability to plug instruments into the kiosk and play along with a song and may allow the user, via vocal controls 206, to incorporate other instruments, such as wind, brass, percussion, etc., into a performance by using vocal controls 206 to compensate for the addition of these musical instruments. For instance, kiosk 102 may include an audio-in port 216 that would allow a user to plug in electronic instruments such as an electric guitar, keyboard, etc., and play along with a song using the instrument as the music video is being recorded. In a further embodiment, kiosk 102 may provide a selection of instruments to users to allow them to select an instrument, for an additional fee, and play along during the video. The instrument function may utilize a standard audio jack such as those found on a typical amp that may be plugged into kiosk 102 and then plays the audio input data from the instrument through the headphones and adds it as an additional audio layer over the final recording. Any electric instrument with the appropriate jack may be used.

Kiosk 102 may include one or more microprocessors, such as a main CPU and an audio DSP, a memory, such as a hard drive, for storing songs and/or other content, a display of displaying visual items, an audio arrangement for providing audio, a communication system for enabling kiosk 102 to communicate with the content servers 300 through a communications network 306, and operating software, including a multitasking operating system, that controls the operation of kiosk 102. The operating software also may be updateable through communication with content server 300 as known to those of skill in the art. Kiosk 102 may further include one or more payment devices, such as coin, bill and/or credit card input devices, for enabling a customer to pay for usage of kiosk 102 in a convenient manner.

Each kiosk 102 may have a local server that may be accessed by kiosk 102. The local servers are respectively connected to kiosk 102 using Ethernet or other types of local connection. In another embodiment, the local server may simply be a logical extension (e.g., partition, directory, or area) of kiosk 102's hard drive, rather than a separate hardware device. The local servers may each include a mirror copy of the master library of musical recordings maintained by content servers 300. The local server may be loaded with the master library by the entity that owns and/or controls kiosk 102 network prior to shipping the local server and kiosk 102 to a kiosk distributor or operator. Of course, over time, the local sever will no longer correspond identically to the central server, due to the fact that content server 300 may be continually updated with additional or new songs. Thus, the local servers also may be updated periodically to maintain a correspondence with the library on the content server 300. This updating can be done, for example, by the content server 300 through communication with kiosk 102 connected with the local servers using, for example, either dial-up, wireless, broadband, wired, Bluetooth, etc. Alternatively, the updating can be done personally with an update tool that can be connected by a routeman or other person directly to kiosk 102 or local server for the purpose of updating the contents of the local server. The portable tool could include a removable storage medium, such as a hard drive, that could be returned to and reused by the owner of the jukebox system for future updates. The tool itself could be kept by the operator or other person in charge of maintaining specific jukeboxes for use upon receipt of the updated removable storage medium from the owner of the jukebox system.

For security reasons, the local server may not include all of the digital data that constitutes any one song that is stored on the local server. In addition, the part of the song that is on the local server is encrypted. Kiosk 102 may contain the missing part of each of the songs on the local server, thereby enabling kiosk 102 to assemble the complete song based on the contents of the local server and the memory on kiosk 102. The missing data located on kiosk 102 is needed in order to decrypt the songs. For example, a single block (or other small fraction) of data for each song may be missing on the local server but present on kiosk 102, and the encryption may be based on the missing block and may proceed on a block by block basis. Thus, none of the blocks can be decrypted without obtaining and/or decrypting a preceding block. This feature provides significant security and prevents or deters theft or other type of unauthorized use or copying of the songs on the local server. Thus, in this embodiment, each local server must be specifically assigned to a specific kiosk 102 so that the decryption described above can be properly performed.

In accordance with an exemplary embodiment, the local servers may also each be individually registered with and identified to content server 300, so that content server 300 may individually manage and monitor each local server. The same is true for kiosk 102 itself, i.e., it may also be registered with content server 300 so that it too can be individually monitored and managed by content server 300. As will be understood from the foregoing description, the local servers become an important and advantageous part of the kiosk system by allowing the contents thereof to be accessed via kiosk 102 to provide additional services (such as providing additional songs) not available on kiosk 102 itself. As will be explained below, the song library of content server 300 and/or the storage capacity itself can be advantageously used to provide services to other kiosks 102, such as fee-based residential and commercial kiosks and/or other fee-based equipment. One use of the local servers may be to provide an immediate song downloading feature.

In one aspect, a user can choose from three (3) different media capture forms: music video, photo, and video messaging. The apparatus is designed to be functionable either within a permanent soundproof kiosk or in a highly mobile and easy-to-assemble kiosk. In one aspect, a kiosk of the current disclosure may be detachably formed for assembly and disassembly. With respect to changing the appearance of unit from one event to another, exchangeable panel casings could comprise the shell of the kiosk enabling for wraps or customization of the exchangeable panels from one event to the next. In one embodiment, the exchangeable panels are made of an aluminum frame with layered felt wood and cardboard. In another embodiment, composite plastic shaped to maximize soundproofing with an aluminum frame may be employed.

Further, kiosks of the current disclosure are designed to be versatile with respect to use of headphones and microphones allowing users and venues the choice of studio quality microphones and headphones or hands-free music video recording supported through embedded microphones and speakers in the enclosure. Further, the current kiosk provides multiple media options the user can choose to engage with not just music. The current kiosk is also designed to facilitate event usage, whereas the entirety of media recorded or shot throughout the course of an event is stored in the servers to be comprehensively aggregated and delivered to the end user.

In a further embodiment, a kiosk of the current disclosure may provide the user the choice of a standard backdrop or a customized backdrop via “green screen”-like technology. With this choice users will be able to record videos, take photos, or send video messages in a variety of locations enhancing the user experience. Additionally, this kiosk is distinct from many other comparable inventions because users will also have the ability to choose between music videos where the user is actually singing and where they are lip syncing to their choice of song. This embodiment may be made possible via use of backdrops of brightly colored fabric or paint, and a process called “chroma key,” also referred to as “green screen” due to the backdrops' color, which is typically a vivid green. Chroma keying allows media technicians to easily separate green screens and panels from the people standing in front of them and replace those backgrounds with basically any desired imagery.

A kiosk may take recorded video (or digitally transferred film), a live video feed or computer output, and isolates and removes a single color in a narrowly defined region of the spectrum. The color is typically bright green or bright blue, because these hues differ so greatly from human skin tones and are not usually found in clothing.

For the effect to work, green areas must be evenly lit and with no visible shadows. Once green screens are identified and digitally removed, just about anything may be added back in, while the parts of the original image that are not green remain unaffected. Chroma keying for live feeds requires hardware that can recognize and manipulate multiple video channels—layers defined by color—while recorded material can be changed in post-production with video- or photo-editing software.

Additionally, a kiosk of the current disclosure may include video messaging, photo, lip syncing of prerecorded audio and the ability to determine the backdrop of the chosen media. The current disclosure has the option to utilize studio quality microphones and headphones or a hands-free experiences with embedded microphones and speakers. Additionally all media captured to on the kiosk can be sent directly to the users' smartphones eliminating the need to search for their media on a webpage.

Further, the background selection may be the choice of the user. The current kiosk is distinct from prior devices based on its array of recorded media choices: music video, personalized video message, and photo. All three of these options are stored on servers and can be sent via mms to the user and are viewable via links in the text. Additionally the lip syncing option provides the user to the ability to record a complete music video without the need to record full audio of the songs performance first-hand. Even further, the current disclosure is designed to be functional in both a permanent soundproof kiosk as well as a highly mobile sound-dampening enclosure.

Kiosks of the current disclosure may include photo, video messaging, and lip-syncing options. All of which are customizable before the recording and instantly uploaded to servers and sent to the user after completion. Additionally, the backdrop for these options is inherently customizable. Further, users have the option of ending their recordings at any time and beginning again should they be displeased with the quality of their performance/images midway through usage. Even further, photos taken with the current disclosure can be edited with filters and other image personalizing features to enhance the user experience.

Accordingly, it is an object of the present disclosure to provide an improved music video kiosk that provides more functionality and interactivity to the user such as by providing distinct and interactive media recording options such as first-hand music video recording, immersive lip-syncing, personalized voice messaging, and interactive photo taking as well as by allowing studio quality music production in association with enhanced features and selections available to the user. Further, the current kiosk can allow a multi-user experience with different individuals simultaneously performing and creating a finished music video product. Even further, the apparatus is designed to be inherently versatile in its installation whether it is in permanent units or highly mobile event-based enclosures. In addition, the finished product may not only be accompanied by instruments but is also shareable.

Kiosks of the present disclosure may provide new media recording options: video messaging, photo taking, and lip-syncing. In one embodiment, improved versatility is provided as installation as permanent kiosks or event-based enclosures is possible. Additionally, the kiosks may provide the immersive feature of personalized backgrounds for media. Moreover, enhanced interactivity may be provided via the photo feature, which may include drawing images with a touch screen, filters, geo-tags, and other snapchat-esque features. Users can engage in this feature after the photos have been taken, after which, particular photos can be selected to edit. Once selected, users have the choice of drawing on the image, adding pre-loaded “stickers” on top of the image, changing the filter overlaid on the image, and select particular geo-tags to be added on top of the image dependent upon the location of the kiosk. All of these options will be clickable on the interactive touchscreen and any changes can be deleted with an eraser function or undo button. Further, kiosks of the current disclosure provide versatility in microphones and headphones. The current kiosk offers users the choice of using headphones of microphones, which are hardwired into the console, or going hands-free and utilizing the speaker and microphones system that is imbedded into the enclosure. This choice is offered to users when they select the karaoke music video option.

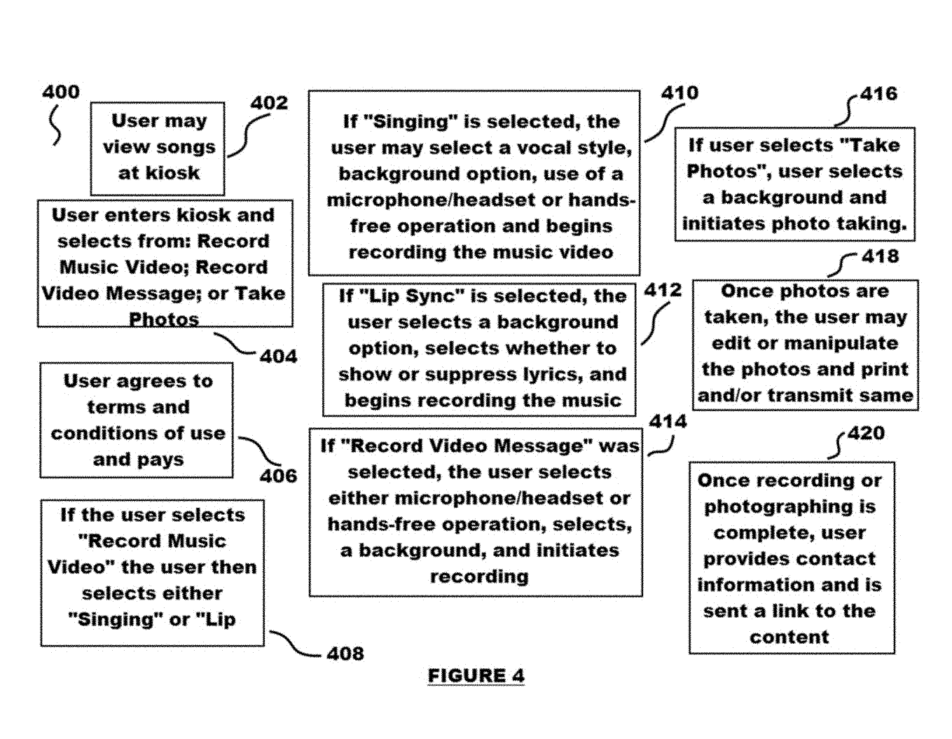

In a further embodiment, referring to FIG. 4, kiosks of the current disclosure may provide an improved user experience 400. At step, 402, the user may view the available songs at the kiosk. At step 404, the user may enter the kiosk and select between three options: record music video, record video message; or take photos. At step 406, the user agrees to the terms and conditions of use and pays. Payment may not occur at this step if the kiosk has been provided as part of an event for use by the patrons. At step 408, if Record Music Video was selected, the user then selects the song and whether to sing the song or to lip sync same along with a vocal track. At step 410, if “Singing” was selected, the user selects a vocal style, selects a background option for the video, selects whether the user will use a microphone/headphone to sing or use the incorporated microphone i the kiosk to go “hands-free” and records the music video. A number of backgrounds will be available to users. This includes landscapes, iconic backdrops at concerts, abstract backgrounds, as well as unrealistic locations such as underwater or on the moon. At step 412, if “Lip Sync” is selected, the user select a background option, selects whether to show lyrics or suppress lyrics and begins recording the video. At step 414, if record video message is selected, the user selects microphone/headphone or hands-free operation, selects a background, and initiates recording. During recording, the user may record a message of a finite duration, such as 30 seconds, 1 minute, 2 minutes, 3 minutes, etc., and payment may vary with the length of the message. Also during record, the user may rewind, delete, over-record, or other options as known to those of skill in the art. At step 416, if take photos was selected, the user selects a background and initiates the kiosk taking photos. During photographing, the user may delete photos, retake photos, or apply filters, geo-tags, or otherwise manipulate the photos such as via editing, inserting artwork, etc. Users can engage in this feature after the photos have been taken, after which, particular photos can be selected to edit. Once selected, users have the choice of drawing on the image, adding pre-loaded “stickers” on top of the image, changing the filter overlaid on the image, and select particular geo-tags to be added on top of the image dependent upon the location of the kiosk. All of these options will be clickable on the interactive touchscreen and any changes can be deleted with an eraser function or undo button. At step 418, once the user is finished taking and manipulating photos, she may print the photos and/or transmit the photos electronically. At step 420, once recording/photographing is complete, the user provides contact information, may be thanked for using the kiosk, and a link is sent to the user. This link may be sent to a smartphone, desktop, or other communication device as known to those of skill in the art.

In one embodiment, the personal video message function on the kiosk allows the user to record up to 60 seconds of video to be sent to a phone number via MMS and/or to be stored on the sever for later use. This function is primarily aimed for events where the kiosk will be present in order to allow guest the opportunity to create video message “gifts” for their hosts. The photo booth function allows the user to engage in activities typical of a traditional photo booth with enhanced interactivity. Users can select their backgrounds, capture images, and edit them after being taken. This process is enhanced by giving the user the option to pause the photo taking process and restart if they are unhappy with a certain image in order to make sure the user does not receive an image they are unhappy with. The lip-syncing function of the kiosk allows users who otherwise would not engage in karaoke or singing the chance to create a music video. Users can select their favorite songs and, just as in traditional karaoke, sing (or “lip sing”) along with the song only the audio in the final music video will be the original audio from the song. This allows users the chance to sing songs that may be out of their vocal range and/or encourage shy users to engage with the kiosk without putting their own voices on display.

In a further embodiment, a kiosk of the current disclosure may provide that after the user enters the kiosk and follows the prompts to begin recording a music video, the unit's recording system will activate in time with the user's chosen song. At this point, audio data is collected by a microphone, which is either held by the user or imbedded into the enclosure of the kiosk. This data is then recorded through an audio mixer, which alters the audio data as it is collected to improve the perceived quality of the user's singing. The audio mixer is connected to the unit's computing device through a fiber optic cable that allows the audio mixer and the computer to exchange data back and forth. The above-mentioned audio data is collected by the unit's computing device and is used to create the audio file for the user's music video. Simultaneously, when the recording system activates, the unit's video camera, which is connected to the unit's computing device via USB, begins recording the visual data for the user's music video. This data is collected by the unit's computer and used to create the visual portion of the user's end video. Once the user's completes their song the unit's recording system will power off and the audio and visual data will be recognized as fully collected. The unit's computer then combines the two separate files into a single music video file using the company's propriety program. At this point, the kiosk uploads the finished file to the company's content management server so it can be distributed back to the user via MMS text.

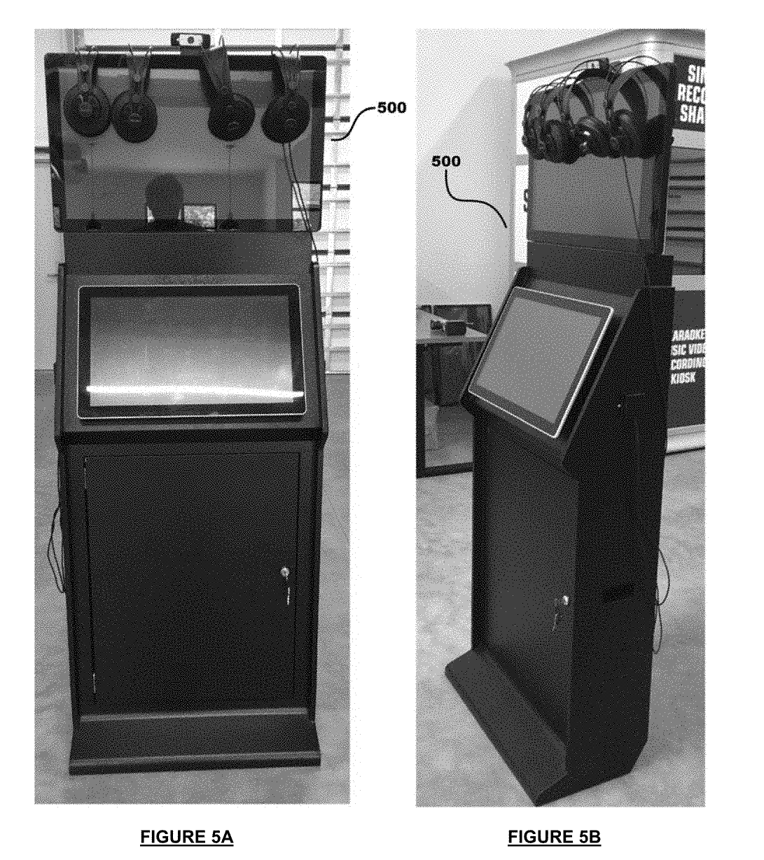

FIG. 5A and FIG. 5B shows one embodiment of a user interface 500 for kiosks of the current disclosure. FIG. 6A shows a side view of a kiosk shell 600 of the current disclosure. FIG. 6B shows an angled rear view of a kiosk shell 600 of the current disclosure.

In one example, after the user enters the kiosk and follows the prompts to begin recording a music video, the unit's recording system will activate in time with the user's chosen song. At this point, audio data is collected by a microphone, which is either held by the user or imbedded into the enclosure of the kiosk. This data is then recorded through an audio mixer, which alters the audio data as it is collected to improve the perceived quality of the user's singing. The audio mixer is connected to the unit's computing device through a fiber optic cable that allows the audio mixer and the computer to exchange data back and forth as known to those of skill in the art. The above-mentioned audio data is collected by the unit's computing device and is used to create the audio file for the user's music video. Simultaneously, when the recording system activates, the unit's video camera, which is connected to the unit's computing device via USB, begins recording the visual data for the user's music video. This data is collected by the unit's computer and used to create the visual portion of the user's end video. Once the user completes their song the unit's recording system will power off and the audio and visual data will be recognized as fully collected. The unit's computer then combines the two separate files into a single music video file using the company's propriety program. At this point, the kiosk uploads the finished file to the company's content management server so it can be distributed back to the user via MMS text.

In a further embodiment, a kiosks of the current disclosure may come in two different forms: a permanent soundproof unit, and an events-based portable unit. The permanent unit is perfect for locations that expect heavier foot-traffic that would be likely to use the kiosk at all times. Additionally, this kiosk is able to have greater sound proofing built in to its structure given that it will not need to be moved very far or frequently. The portable, events-based kiosk is able to serve a different type of clientele who expect less or sporadic usage of the kiosk. The portable unit is far lighter than the permanent unit and can be built by a team of two people in under 10 minutes (whereas the permanent unit could take the same team upwards of 2 hours to set up). Further, the event-based kiosk is designed to have an easily changed exterior, in one embodiment, kiosk shell 600, in order to match the type of event it is being used at whether that is a wedding, child's party, or corporate function, by simply applying a shell 600 the corresponds, matches, or is themed with the event where the kiosk is being used. Ultimately, the portable kiosk enclosure is ideal for servicing the event rental industry growing the potential reach of the product outside of permanent entertainment spaces.

In one embodiment, the current enclosure for the kiosk is specifically designed for event purposes and high mobility is capable of being put together by a team of two in under 10 minutes with zero tools and little prior knowledge of the unit. For purposes of example only and not intended to be limiting, the enclosure is made up of 14, 31″×42″ wall panels and two 31″×63″ ceiling panels. The wall panels are placed two units high with the top and bottom panels interlocking with a metal clasp in a fitted grove. The stacked panels are then connected to their neighboring panels via the same grooved clasps along their sides. The panels are put together in a spiral pattern until a 31″×84″ entrance is left. At this point the two ceiling panels are laid on top of the enclosure in their appropriate groves and screwed in place using wing-nuts. Lastly a sound-dampening curtain is hung along the inside track covering the entrance to the enclosure. Additional acoustic paneling, used for sound-proofing, can also be added along the inside walls of the enclosure if desired using a series of Velcro and hooks. Disassembly may be accomplished by simply reversing the order of the steps.

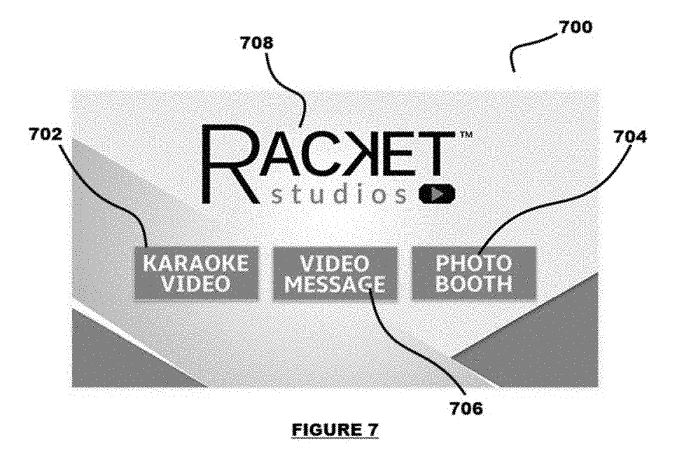

FIG. 7 shows one embodiment of a start screen that may be used with a kiosk of the current disclosure. Start screen 700 allows a user to select from the kiosk's multifunctional format by selection karaoke video 702, video message 704 and/or photo booth 704. Further, a user may be able to use one function then immediately select another function upon completion of the first selected function. Additionally, branding 708 may be varied in order to offer venue-specific advertising to users.

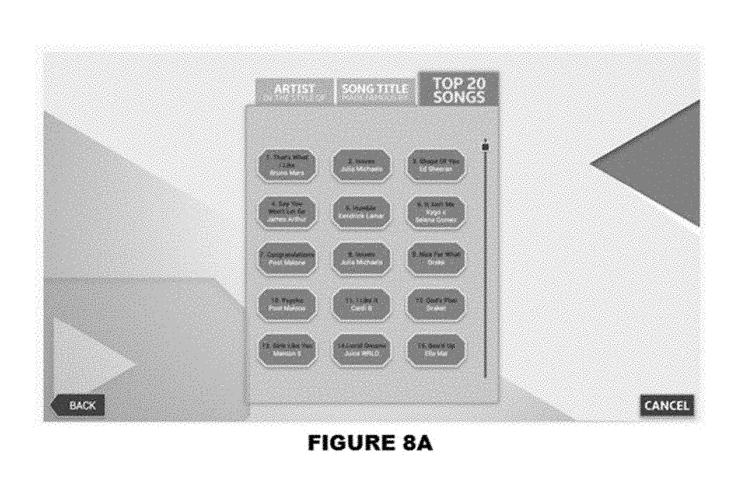

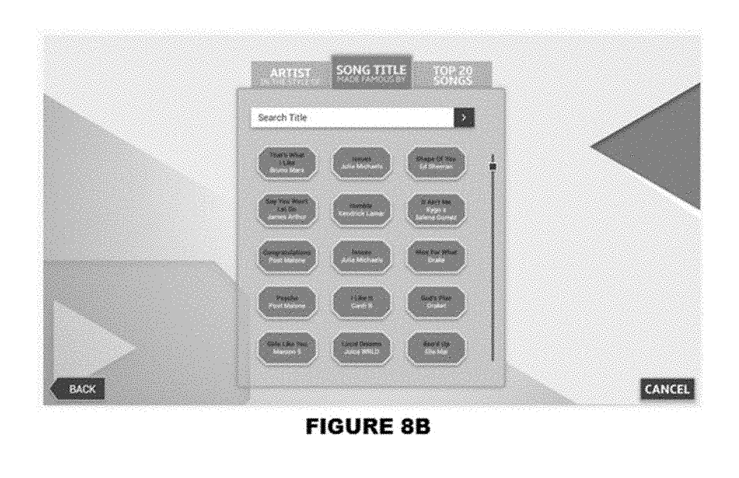

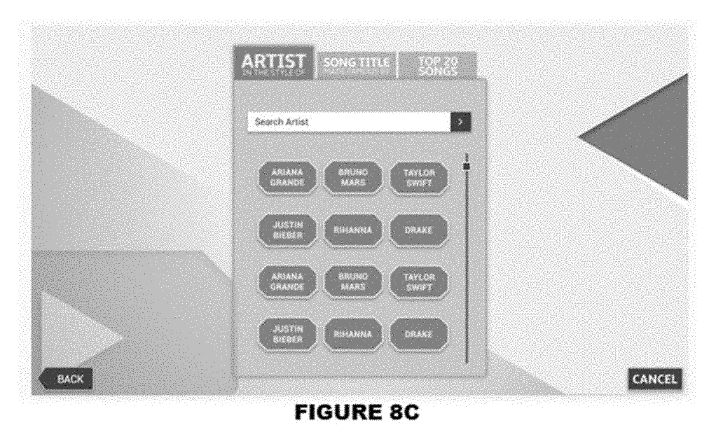

FIGS. 8A, 8B, and 8C show embodiments of selection screens that may be used with a kiosk of the current disclosure. Users may select from artists, song titles, or genre rankings, such as Top 20 Songs, all depending on the user's preference.

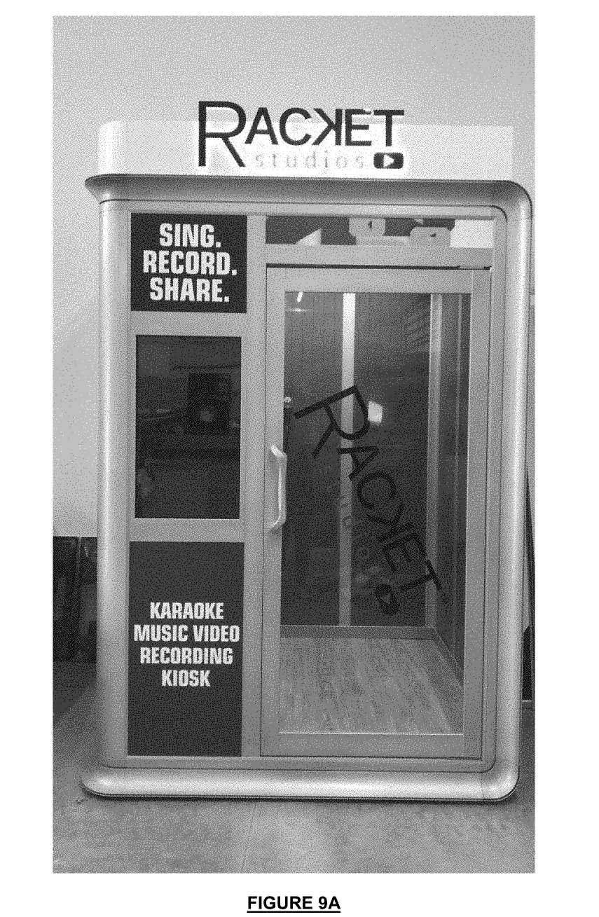

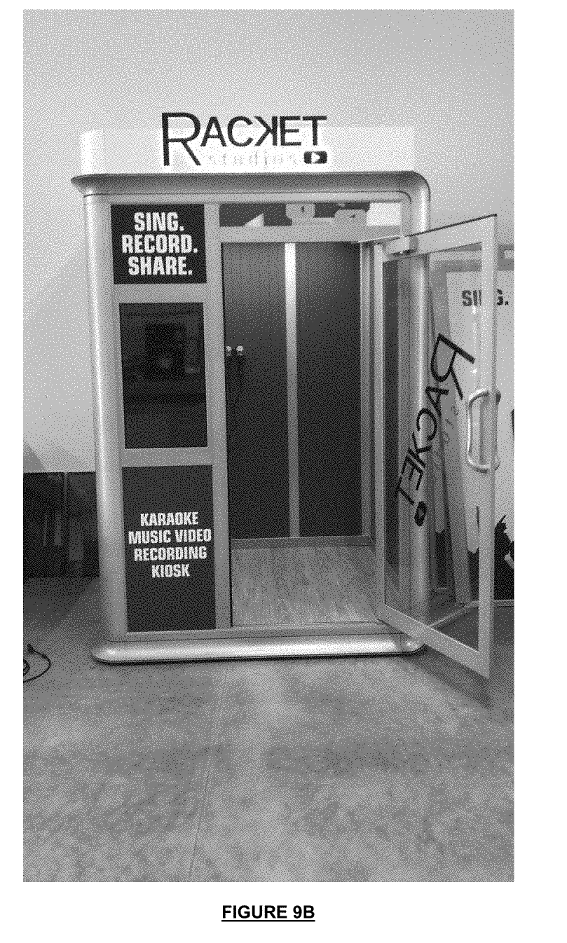

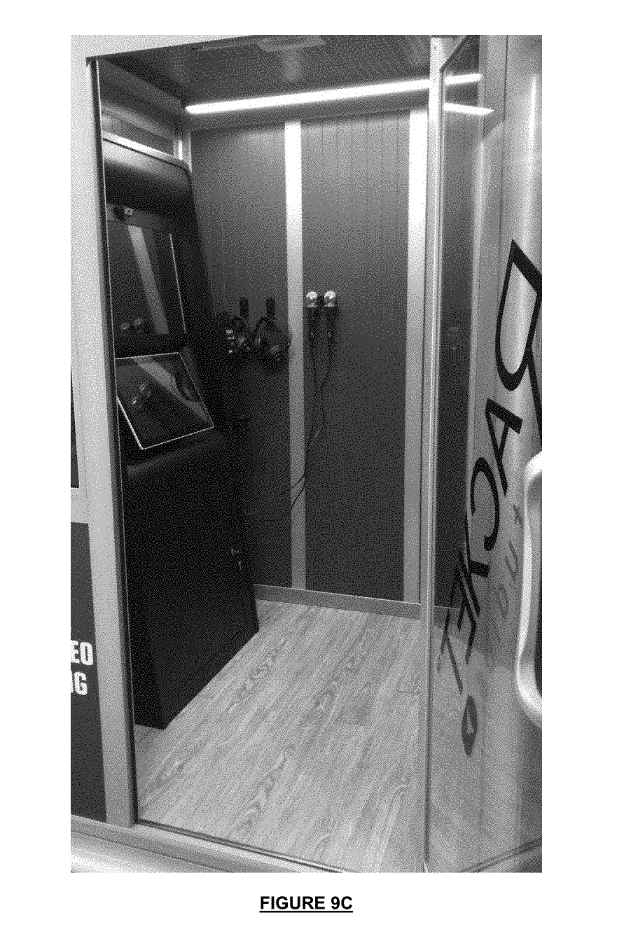

FIGS. 9A, 9B and 9C show different views of one embodiment of the current disclosure.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A multi-media kiosk comprising:
a kiosk shell;
a user interface on an exterior of the kiosk;
a home screen located within the kiosk shell;
at least one camera within the kiosk shell;
at least one microphone within the kiosk shell; and
wherein the multi-media kiosk allows for creation of music videos, video messages, or
taking photographs, all within the kiosk.

2. The multi-media kiosk of claim 1, wherein the user interface provides access to a song catalog.

3. The multi-media kiosk of claim 1, wherein the home screen allows application of vocal controls to modify audio characteristics of the music videos and video messages.

4. The multi-media kiosk of claim 1, wherein the kiosk contains at least one hands-free microphone built into the kiosk shell and at least one hand-held microphone within the kiosk shell.

5. The multi-media kiosk of claim 1, wherein the kiosk allows creation of customized music videos, video messages and/or photographs.

6. The multi-media kiosk of claim 1, wherein the kiosk allows for selecting a customized background for the music videos, video messages and/or photographs.

7. The multi-media kiosk of claim 1, wherein the kiosk allows for editing photographs.

8. The multi-media kiosk of claim 1, wherein the kiosk transmits a link allowing access to completed music videos, video messages, or photographs crated via the kiosk.

9. The multi-media kiosk of claim 1, wherein the kiosk shell may be customized by changing an outer appearance of the kiosk shell.

10. The multi-media kiosk of claim 3, wherein a mixer board is included in the kiosk to allow for control of the audio characteristics of the music videos and video messages.

11. The multi-media kiosk of claim 1, wherein the kiosk further includes inputs for musical instruments.

12. The multi-media kiosk of claim 1, wherein head phones and speakers are provided to allow hearing audio from the kiosk.

13. The multi-media kiosk of claim 1, wherein the kiosk further comprises sound proofing material substantially surrounding an interior of the kiosk.

14. A multi-media kiosk comprising:
a kiosk shell;
a user interface on an exterior of the kiosk;
a home screen located within the kiosk shell;
at least one camera within the kiosk shell;
at least one microphone within the kiosk shell;
wherein the multi-media kiosk allows a user to choose among creating music videos,
creating video messages, or taking photographs, all within the kiosk; and
wherein the kiosk allows for hands-free operation or directed input via headphones and at least one hand-held microphone.

15. The multi-media kiosk of claim 14 wherein the home screen allows application of vocal controls to modify audio characteristics of the music videos and video messages.

16. The multi-media kiosk of claim 14, wherein the kiosk contains at least one hands-free microphone built into the kiosk shell and at least one hand-held microphone within the kiosk shell.

17. The multi-media kiosk of claim 14, wherein the kiosk allows for selecting a customized video background.

18. The multi-media kiosk of claim 14, wherein the kiosk allows for editing photographs.

19. The multi-media kiosk of claim 14, wherein the kiosk transmits a link allowing access to completed music videos, video messages, or photographs crated via the kiosk.

20. The multi-media kiosk of claim 14, wherein the kiosk shell may be customized by changing an outer appearance of the kiosk shell.

21. A mobile multi-media kiosk comprising:
a kiosk shell;
a user interface;
a home screen located within the kiosk shell;
at least one camera within the kiosk shell;
at least one microphone within the kiosk shell;
wherein the mobile multi-media kiosk allows a user to choose among creating music videos, creating video messages, or taking photographs, all within the kiosk;
wherein the kiosk allows for hands-free operation or directed input via headphones and at least one hand-held microphone; and
wherein the kiosk components are detachably joined and may be dismantled and reassembled in various locales.
